(19) United States
(12) Patent Application Publication
(10) Pub. No.: US 2018/0255766 A1
(43) Pub. Date: Sep. 13, 2018

(54) PORTABLE PHYSIOLOGICAL TRANSPORT UNIT

(71) Applicant: CYTOBIOSCIENCE, INC., San Antonio, TX (US)

(72) Inventors: Larry Dick, San Antonio, TX (US); James Garvin, San Antonio, TX (US)

(21) Appl. No.: 15/622,522

(22) Filed: Jun. 14, 2017

Related U.S. Application Data
(60) Provisional application No. 62/469,649, filed on Mar. 10, 2017.

(51) Int. Cl. A01N 1/02; H05B 1/02

(52) U.S. Cl. CPC A01N 1/0273; A01N 1/0242; H05B 1/0247

(57) ABSTRACT

A simple, compact, and disposable unit for transporting living cells at living-body temperature is disclosed. The transport unit may include a box enclosure with two resistive heating elements on opposite sides of a container with living cells in the container. A portable, disposable power source may be located in the box to provide power to the resistive heating elements. One or more controllers may be located in the box and used to control power to the resistive heating elements and maintain a temperature of the living cells at living-body temperatures.

### PRIORITY CLAIM

This patent claims priority to provisional patent application No. 62/469,649 entitled “PORTABLE PHYSIOLOGICAL TRANSPORT UNIT,” filed Mar. 10, 2017, which is incorporated by reference in its entirety as if fully set forth herein.

### BACKGROUND

### 1. Field of the Invention

Embodiments disclosed herein relate to the transport and temporary retention of living biological cells. More particularly, embodiments described herein relate to devices and methods for transporting and temporarily storing living biological cells at typical living body temperature of such cells transported or temporarily stored.

### 2. Description of Related Art

Hospitals and scientific labs typically incubate (or retain) living cells in large incubators (e.g., incubator “ovens”). There is not, however, a convenient and affordable way to retain living cells outside these large incubators for extended periods of time. Additionally, shipping living cells between labs, between hospitals, between labs and hospitals, and/or between other entities at typical living-body temperatures has largely been nearly impossible up to this point.

The typical method for biological cell transportation is ultra-low temperature cryogenic freezing. Cryogenic freezing, however, may potentially destroy a significant amount of such cells, which may or may not able to be thawed and used later. Cryogenic freezing of biological cells and shipping of such cells while frozen is also not generally convenient and/or is extremely time consuming. Some existing solutions for transporting living cells at typical living-body temperatures have arisen but are complicated and expensive. Thus, there is a need for a convenient, simple, and affordable device and method for transporting living cells at typical living-body temperatures to ensure reliable transportation and retention of the living cells.

### SUMMARY

In certain embodiments, a living cell transport apparatus includes a box with at least one opening. At least one incubator compartment may be located in the box. One living cell container may be positioned in each incubator compartment through at least one opening in the box. The incubator compartment may include a first support member, a first resistive heating element coupled to a surface of the first support member, a second support member, a second resistive heating element coupled to a surface of the second support member, and a temperature probe. In some embodiments, the first support member and/or the second support member are insulated. The first resistive heating element and the first insulated support member may support the living cell container when the living cell container is positioned in the incubator compartment. The second resistive heating element may be positioned on an opposing side of the living cell container from the first resistive heating element when the living cell container is positioned in the incubator compartment. A cover may be coupled to the box to close off each opening in the box. A portable power source may be located in the box. At least one temperature controller may be located in the box. That controller may be coupled to the first and second resistive heating elements, the temperature probe, and the portable power source. The temperature controller may control the temperature in the inside of the incubator compartment by controlling electrical power provided to the first and second resistive heating elements from the portable power source. The temperature in the incubator compartment may be assessed by using the temperature probe.

In certain embodiments, a living cell transport apparatus includes a box with an opening and a cover coupled to the box to close off the opening in the box. A first support member may be positioned in the box with a first resistive heating element attached to a surface of the first support member. A second support member may be attached to the cover with a second resistive heating element attached to a surface of the second support member. The first support member and/or the second support member may be insulated. The surface of the second support member may face the surface of the first support member when the cover closes off the opening in the box. The surface of the second support member may face the surface of the first support member such that the first resistive heating element and the second resistive heating element oppose each other and define a space between the first resistive heating element and the second resistive heating element. A living cell container may be positioned in the space between the first resistive heating element and the second resistive heating element. A portable power source may be located in the box. A temperature probe may be positioned in the space between the first resistive heating element and the second resistive heating element. At least one temperature controller may be located in the box and coupled to the first and second resistive heating elements, the temperature probe, and the portable power source. The temperature controller may control the temperature within the space between the first resistive heating element and the second resistive heating element by controlling electrical power provided to the first and second resistive heating elements from the portable power source. The temperature in the space between the first resistive heating element and the second resistive heating element may be assessed using the temperature probe.

In certain embodiments, a system for transporting living cells includes a box with an opening and a cover coupled to the box to close off the opening in the box. A first support member may be positioned in the box with a first resistive heating element attached to a surface of the first support member. A second support member may be attached to the cover with a second resistive heating element attached to a surface of the second support member. In some embodiments, the first support member and/or second support member are insulated. The surface of the second support member may face the surface of the first support member when the cover closes off the opening in the box. The surface of the second support member may face the surface of the first support member such that the first resistive heating element and the second resistive heating element face each other. A living cell container with living cells may be positioned between the first resistive heating element and the second resistive heating element. A temperature probe may be positioned between the first resistive heating element and the second resistive heating element. A portable power source may be located in the box. At least one controller may be located in the box and coupled to the first and second resistive heating elements, the temperature probe, and the portable power source. The controller may control the temperature surrounding the living cell container by controlling electrical power provided to the first and second resistive heating elements from the portable power source.

### BRIEF DESCRIPTION OF THE DRAWINGS

Features and advantages of the apparatus of the embodiments described in this disclosure will be more fully appreciated by reference to the following detailed description of presently preferred but nonetheless illustrative embodiments in accordance with the embodiments described in this disclosure when taken in conjunction with the accompanying drawings in which:

FIG. 1 depicts a representation of an embodiment of a transport unit.

FIG. 2 depicts an exploded view representation of an embodiment of components of a transport unit.

While embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean including, but not limited to.

Similarly, the words “have,” “having,” and “has” also indicate open-ended relationships, and thus mean having, but not limited to. The terms “first,” “second,” “third,” and so forth as used herein are used as labels for nouns that they precede, and do not imply any type of ordering (e.g., spatial, temporal, logical, etc.) unless such an ordering is otherwise explicitly indicated. For example, a “third element connected to an apparatus” does not preclude scenarios in which a “fourth element connected to the apparatus” is connected prior to the third element, unless otherwise specified. Similarly, a “second” feature does not require that a “first” feature be implemented prior to the “second” feature, unless otherwise specified.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 paragraph (f), interpretation for that component.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION OF EMBODIMENTS

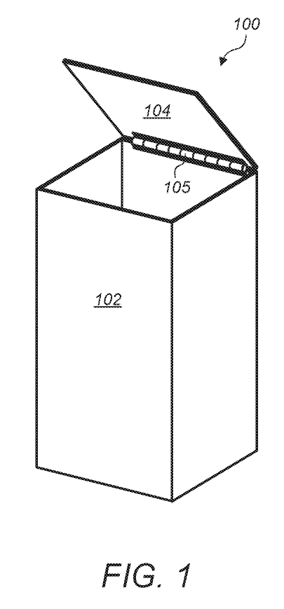

FIG. 1 depicts a representation of an embodiment of transport unit 100. In certain embodiments, transport unit 100 includes lower portion 102 and upper portion 104. Upper portion 104 may be a lid or cover for lower portion 102. Lower portion 102 and upper portion 104 may be coupled together to form transport unit 100. Lower portion 102 may be, for example, a single body (e.g., monolithic body) “squared cylinder.” In certain embodiments, lower portion 102 is a box having an open end (e.g., a rectangular box with an open end). Upper portion 104 may be a single body (e.g., monolithic body) that forms the lid or cap for the lower portion 102. In certain embodiments, upper portion 104 is a hinged lid used to open and close access to lower portion 102 (e.g., the upper portion is coupled to the lower portion with hinge 105). As shown in FIG. 1, transport unit 100 is a “squared cylinder” or rectangular box. Transport unit 100 may, however, have other shapes reasonably suitable for use to enclose the components of the transport unit described herein. For example, transport unit 100 may be a circular cylinder, a “rectangular cylinder,” or any other suitable cylindrical shape.

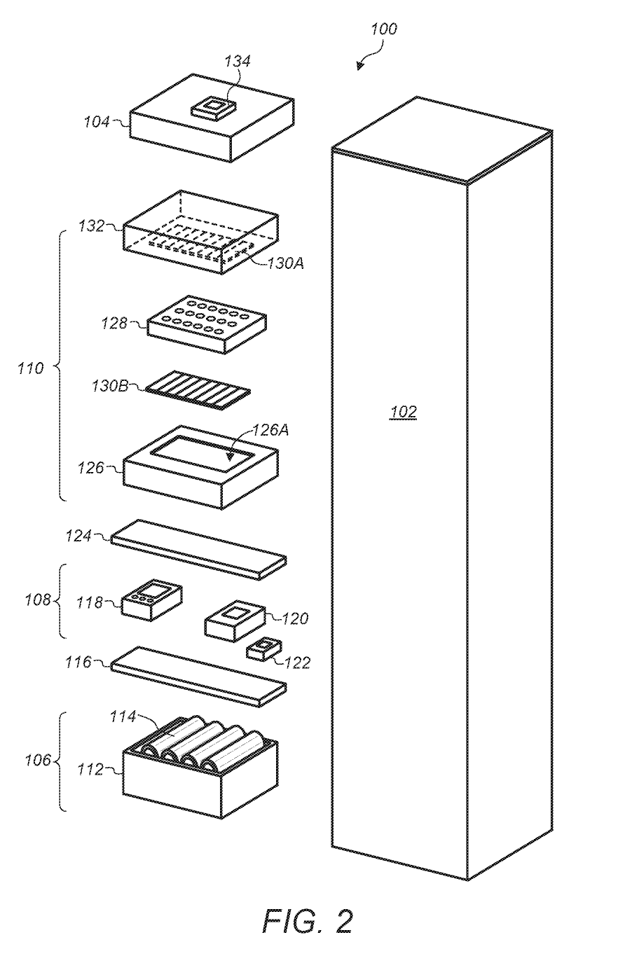

Lower portion 102 and upper portion 104 may together form a case or enclosure for enclosing components of transport unit 100 (e.g., the components described in detail below and shown in FIG. 2). In certain embodiments, lower portion 102 and upper portion 104 are made as existing pieces that the components are placed into to form transport unit 100. In some embodiments, lower portion 102 and upper portion 104 are formed as a shell around the components to form transport unit 100. In certain embodiments, lower portion 102 and upper portion 104 form an environmentally sealed enclosure when the upper portion is closed (e.g., the lid is closed). Forming the environmentally sealed enclosure inhibits cells placed inside transport unit 100 from being contaminated or affected by the outside environment while the cells are inside the transport unit.

FIG. 2 depicts an exploded view representation of an embodiment of the components of transport unit 100. The components of transport unit 100 are shown in exploded view for ease of depiction of the different components. It is to be understood that the components shown in FIG. 2 reasonably fit inside and are enclosed by lower portion 102 and/or upper portion 104. The components may, for example, be stacked together inside lower portion 102 and/or upper portion 104 according to the layout of components shown in FIG. 2. In certain embodiments, transport unit 100 includes three compartments separated by one or more layers of insulation—battery compartment 106, controller compartment 108, and incubator compartment 110.

Battery compartment 106 includes a power source for electrical components in transport unit 100. In certain embodiments, battery compartment 106 includes battery holder 112 and batteries 114. Battery holder 112 may be, for example, any standard battery holder. The type of battery holder 112 may be determined by the type of batteries 114 desired to be used in transport unit 100. For example, the type and number of batteries 114 may be determined by the voltage requirements of electronic components in transport unit 100 and/or a desired longevity of use of the transport unit by the user.

In certain embodiments, batteries 114 provide direct current (DC) power. Batteries 114 may include any suitable arrangement of battery sizes and numbers. For example, batteries 114 may be any number of AAA, AA, C, D, 9-volt batteries, or any other suitable battery type. In one embodiment, battery compartment 106 includes 8 D-cell batteries 114 in battery holder 112. In such an embodiment, batteries 114 may supply transport unit with 12 volts of power and a capacity sufficient for long term useful battery life. Batteries 114 may be alkaline batteries or any rechargeable battery types (e.g., Nicad or Li-ion). Typically, alkaline batteries (or similar disposable batteries) may be used for ease of shipping and disposal as rechargeable batteries are often not shippable via some types of transport (e.g., air transport).

In certain embodiments, separator 116 separates battery compartment 106 and controller compartment 108. Separator 116 may be a bare plate of insulation (e.g., insulation without any reflective coating or other coating). The insulation may include, for example, polystyrene foam, another cellular foam, and/or another insulating (non-conducting) material. In certain embodiments, separator 116 provides support to controller compartment 108 (e.g., separator 116 is a support member). In some embodiments, separator 116 may be optional or eliminated entirely. In such embodiments, transport unit 100 may be more compact.

In certain embodiments, controller compartment 108 includes temperature controller 118 and current controller 120. Temperature controller 118 and current controller 120 are powered by batteries 114. Wires or other electrical connections may be used to couple temperature controller 118 and current controller 120 to batteries 114. The electrical connections may pass through separator 116 or go around the separator. In some embodiments, separator 116 may be optional or eliminated entirely. In such embodiments, transport unit 100 may be more compact.

Temperature controller 118 may be a standard temperature controller (e.g., a standard digital temperature controller) that uses a temperature probe to detect temperatures. The temperature probe (not shown) for temperature controller 118 may be positioned in incubator compartment 110. The temperature probe may connect to temperature controller 118 either through a wired connection or wirelessly. Temperature controller 118 is used to control temperature in incubator compartment 110 by activating or deactivating heating elements 130 (described in detail below) in the incubator compartment. For example, temperature controller 118 may activate heating elements 130 when the temperature in incubator compartment 110 is below a minimum temperature (e.g., a minimum temperature set in the controller) and deactivate the heating elements when the temperature in the incubator compartment exceeds a maximum temperature (e.g., a maximum temperature set in the controller). In some embodiments, temperature controller 118 is used to control temperature in incubator compartment 110 by controlling the temperature between heating elements 130A and 130B and/or the temperature surrounding cell container 128.

The minimum and maximum temperatures set may be determined based on a desired temperature or temperature range provided to temperature controller 118. For example, the minimum and maximum temperatures set may be within 1° C. of a desired temperature input into temperature controller 118. In certain embodiments, the desired temperature is input into temperature controller 118 by a manufacturer of transport unit 100 (with the desired temperature being set according to specified use of the transport unit). In some embodiments, the desired temperature is input into temperature controller 118 by a user of transport unit 100. For example, transport unit 100 may include an input terminal for programming the desired temperature into temperature controller 118.

The power requirements (e.g., voltage and current) for temperature controller 118 may be matched to the power requirements for heating elements 130 and the voltage provided by batteries 114. In certain embodiments, temperature controller 118 is a 12-volt temperature controller used with D-cell batteries 114 and controlling 12-volt heating elements 130.

Current controller 120 may be a standard analog controller that uses a temperature probe to detect temperatures in incubator compartment 110. The temperature probe used by current controller 120 may be the same temperature probe used by temperature controller 118 or it may be a separate temperature probe. Current controller 120 is coupled to temperature controller 118 with the current controller being coupled between batteries 114 and the temperature controller. Current controller 120 may be used to activate or deactivate electrical current supply to temperature controller 118 based on measurements from the coupled temperature probe. Current controller 120 activates or deactivates electrical current supply to temperature controller 118 based on whether a maximum temperature (e.g., a maximum temperature set in the current controller) has been attained or not. In some embodiments, current controller 120 may be optional or eliminated entirely. In such embodiments, transport unit 100 may be more compact. Current controller 120 may be power matched to temperature controller 118. For example, current controller 120 may be a 12-volt controller alongside a 12-volt temperature controller 118.

In some embodiments, temperature readout 122 is located inside controller compartment 108. Temperature readout 122 provides a temperature readout that is independent of the temperatures measured by temperature controller 118 and/or current controller 120. Thus, temperature readout 122 uses a separate temperature probe from temperature controller 118 and/or current controller 120. The temperature probe is positioned inside incubator compartment 110 and connected to the temperature readout 122 using either a wired or wireless connection. Additionally, temperature readout 122 may be independently powered (e.g., has its own power source other than batteries 114) from temperature controller 118 in order to provide a temperature reading that is objectively separate from the temperature reading of the temperature controller. In some embodiments, current controller 120 may be optional or eliminated entirely. In such embodiments, transport unit 100 may be more compact.

In certain embodiments, temperature readout 122 includes, or is coupled to, a display screen (e.g., an LED or LCD display screen). The display screen may be, for example, display 134 located on upper portion 104 or another display positioned on the outside of transport unit 100. In some embodiments, temperature readout 122 remotely displays the temperature (e.g., using a wireless connection to an external display). In some embodiments, temperature readout 122 includes, or is coupled to, a temperature recording device. The temperature recording device may record temperature over time (e.g., during shipment of transport unit 100) and store the temperature readings in a memory of the device. The recorded temperature data may be provided to a separate unit (e.g., may be downloaded wirelessly or through a port connection such as a micro-USB connection) in order for the temperature data to be analyzed. For example, the recorded temperature data may be analyzed to ensure incubator compartment 110 remained at proper temperatures during shipment of transport unit 100. In some embodiments, temperature readout 122 is located in or attached to upper portion 104 instead of being located in controller compartment 108. In some embodiments, display 134 may be optional or eliminated entirely. In such embodiments, transport unit 100 may be more compact.

Separator 124 may separate controller compartment 108 from incubator compartment 110, as shown in FIG. 2. Separator 124 may be a bare plate of insulation (e.g., insulation without any reflective coating or other coating). The insulation may include, for example, polystyrene foam, another cellular foam, and/or another insulating material. In some embodiments, separator 124 may be optional or eliminated entirely. In such embodiments, transport unit 100 may be more compact

In certain embodiments, separator 126 is positioned between separator 124 and cell container 128 in incubator compartment 110. Separator 126 may include insulation similar to insulation in separator 124. The insulation in separator 126 may be encapsulated with reflective foil (or another reflective material). In some embodiments, the reflective foil is only positioned on the upper surface of separator 126. The reflective foil reflects heat from heating elements 130 towards cell container 128 to conserve and retain heat in incubator compartment 110.

In certain embodiments, separator 126 includes recess 126A on its upper facing surface. Heating element 130B may be positioned in recess 126A. Recess 126A may thus be used to support and properly position heating element 130B inside incubator compartment 110 (e.g., separator 126 is a support member for heating element 130B). In some embodiments, heating element 130B is attached to the reflective foil of separator 126. Attaching heating element 130B to the reflective foil may inhibit the heating element from inadvertently moving out of recess 126A. Separator 126 and heating element 130B may provide support for cell container 128 when the cell container is positioned inside incubator compartment 110.

Separator 132 is positioned above cell container 128 and on the opposite side of the cell container from separator 126. Separator 132 may be substantially similar to separator 126. Separator 132 may have a recess on its lower facing surface. The recess in separator 132 may face recess 126A in separator 126. Heating element 130A may be positioned in the recess of separator 132 (as shown in FIG. 2) and attached to the reflective foil of the separator (e.g., separator 132 is a support member for heating element 130A).

Heating elements 130A, 130B may be electrically-powered resistance heaters. Heating elements 130A, 130B are placed on opposing sides of cell container 128. Placing heating elements 130A, 130B on opposing sides of cell container 128 may provide more uniform heating of the cell container. Heating elements 130A, 130B provide the heat needed to maintain living-body temperatures required by the living cells in cell container 128. Heating elements 130A, 130B may be powered by batteries 114 through temperature controller 118 and current controller 120, which control the heating elements and are power matched to the heating elements as described herein.

In certain embodiments, heating elements 130A, 130B are electrically resistive wire or strip elements encased in an insulating material. For example, heating elements 130A, 130B may be copper wire or copper strips encased in a polyimide film or a flexible foam sheet. Heating elements 130A, 130B may provide ambient heating of cell container 128 and the living cells inside the cell container.

In certain embodiments, cell container 128 is any standard cell container provided by a user to be transported or retained in transport unit 100. Cell container 128 may contain living cells (or other samples that need to be maintained at elevated temperatures). The living cells in cell container 128 may be placed in transport unit 100 to be retained at living-body temperatures (e.g., normal human or animal body temperatures) and/or shipped (transported) to another location (e.g., a lab or hospital). Examples of cell containers that may be used as cell container 128 include, but are not limited to, Petri dishes, MEA plates, well plates, and flasks. In one embodiment, cell container 128 is a 96-well MEA plate. Transport unit 100 may be sized according to the specific cell container desired to be placed inside the transport unit. Sizing transport unit 100 according to cell container 128 maintains compactness in the transport unit (relative to the size of the cell container).

In certain embodiments, separator 132 and heating element 130A are attached to upper portion 104 (e.g., the lid of transport unit 100). With separator 132 and heating element 130A to upper portion 104, the separator and heating element move with the upper portion when transport unit 100 is opened by lifting the upper portion (as shown in FIG. 1). Having separator 132 and heating element 130A move with upper portion 104 provides access to insert/remove cell container 128 without having to separately remove and install the separator and the heating element.

Transport unit 100, as described herein, provides a simple, convenient, and affordable solution for maintaining living cells (or other samples) at an elevated temperature such as the typical living-body temperature for the living cells. Transport unit 100 provides a compact and controlled environment to maintain living cells at desired temperatures for retaining the living cells and/or shipping (transporting) the living cells between locations for specified periods of time without the need for external power sources and/or the use of chemical heat packs. For example, the living cells may be maintained at the desired temperatures between collection and storage of the cells and/or shipment of the cells from one location to another location. Additionally, transport unit 100 is highly portable (due to its compactness) and may be readily disposed of into standard disposal waste systems after its usage lifetime (though ease of disposal may somewhat depend on the power source used in the transport unit).

In certain embodiments, transport unit 100 maintains a temperature in cell container 128 within reasonable tolerances of a desired temperature determined by the user (e.g., a temperature programmed into temperature controller 118). For example, transport unit 100 may maintain the temperature in cell container 128 within ±1° C. of the desired temperature. In certain embodiments, transport unit 100 is able to maintain the temperature in cell container 128 for a reasonable length of time to allow transport of the cell container. For example, transport unit 100 may be able to maintain the desired temperature in cell container 128 for at least about 72 hours of continuous use of the transport unit. In a simple operation, transport unit 100 may allow a user to just insert cell container 128 into the unit, close the lid (e.g., upper portion 104), and activate the unit (e.g., activate the heating elements).

It is to be understood the invention is not limited to particular systems described which may, of course, vary. It is also to be understood that the terminology used herein is for the purpose of describing particular embodiments only, and is not intended to be limiting. As used in this specification, the singular forms “a,” “an” and “the” include plural referents unless the content clearly indicates otherwise. Thus, for example, reference to “an element” includes a combination of two or more devices and reference to “a cell” includes mixtures of cells.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A living cell transport apparatus, comprising:
a box comprising an opening;
an incubator compartment located in the box, wherein a living cell container is configured to be positioned in the incubator compartment through the opening in the box, the incubator compartment comprises:
a first support member;
a first resistive heating element coupled to a surface of the first support member, the first resistive heating element and the first support member being configured to support the living cell container when the living cell container is positioned in the incubator compartment;
a second support member;
a second resistive heating element coupled to a surface of the second support member, the second resistive heating element being configured to be positioned on an opposing side of the living cell container from the first resistive heating element when the living cell container is positioned in the incubator compartment; and
a temperature probe;
a cover coupled to the box, the cover being configured to close off the opening in the box;
a portable power source located in the box; and
at least one controller located in the box with the at least one controller being coupled to the first and second resistive heating elements, the temperature probe, and the portable power source, wherein the at least one controller is configured to control a temperature inside the incubator compartment by controlling electrical power provided to the first and second resistive heating elements from the portable power source, the temperature in the incubator compartment being assessed using the temperature probe.

2. The apparatus of claim 1, further comprising a temperature readout coupled to a second temperature probe, the second temperature probe being positioned in the incubator compartment, wherein the temperature readout assesses the temperature in the incubator compartment using the second temperature probe.

3. The apparatus of claim 1, wherein the second resistive heating element and the second support member are attached to the cover.

4. The apparatus of claim 1, wherein the portable power source comprises one or more disposable batteries.

5. The apparatus of claim 1, wherein the at least one controller comprises at least a temperature controller.

6. The apparatus of claim 5, wherein the temperature controller is configured to control the temperature in the incubator compartment by activating or deactivating electrical power provided to the first and second resistive heating elements based on the temperature assessed using the temperature probe.

7. The apparatus of claim 5, wherein the at least one controller comprises at least a current controller, and wherein the current controller is coupled between the temperature controller and the portable power source, the current controller being configured to deactivate electrical power to the temperature controller when the temperature assessed using the temperature probe increases above a selected temperature.

8. The apparatus of claim 1, further comprising reflective foil attached to the surfaces of the first support member and the second support member.

9. The apparatus of claim 1, wherein the portable power source and the at least one controller are separated from the incubator compartment by the first support member.

10. The apparatus of claim 1, wherein at least one of the first support member and the second support member comprises an insulated support member.

11. A living cell transport apparatus, comprising:
a box comprising an opening;
a cover coupled to the box, the cover being configured to close off the opening in the box;
a first support member positioned in the box;
a first resistive heating element attached to a surface of the first support member;
a second support member attached to the cover;
a second resistive heating element attached to a surface of the second support member;
wherein the surface of the second support member faces the surface of the first support member when the cover closes off the opening in the box, the surface of the second support member facing the surface of the first support member such that the first resistive heating element and the second resistive heating element oppose each other and define a space between the first resistive heating element and the second resistive heating element, wherein a living cell container is configured to be positioned in the space between the first resistive heating element and the second resistive heating element;
a portable power source located in the box;
a temperature probe positioned in the space between the first resistive heating element and the second resistive heating element; and
at least one controller located in the box, the at least one controller being coupled to the first and second resistive heating elements, the temperature probe, and the portable power source, wherein the at least one controller is configured to control a temperature in the space between the first resistive heating element and the second resistive heating element by controlling electrical power provided to the first and second resistive heating elements from the portable power source, the temperature in the space between the first resistive heating element and the second resistive heating element being assessed using the temperature probe.

12. The apparatus of claim 11, wherein the at least one controller comprises at least a temperature controller.

13. The apparatus of claim 12, wherein the temperature controller is configured to activate or deactivate electrical power provided to the first and second resistive heating elements to maintain the temperature assessed using the temperature probe between a minimum temperature and a maximum temperature set in the temperature controller.

14. The apparatus of claim 12, wherein the at least one controller comprises at least a current controller, and wherein the current controller is coupled between the temperature controller and the portable power source, the current controller being configured to deactivate electrical power to the temperature controller when the temperature assessed using the temperature probe increases above a maximum temperature set in the current controller.

15. The apparatus of claim 11, further comprising reflective foil attached to the surfaces of the first support member and the second support member.

16. The apparatus of claim 11, wherein the first resistive heating element is positioned in a recess in the surface of the first support member.

17. The apparatus of claim 11, further comprising a temperature display positioned on an external surface of the apparatus, wherein the temperature display displays a temperature assessed using a second temperature probe positioned in the space between the first resistive heating element and the second resistive heating element.

18. A system for transporting living cells, comprising:
a box comprising an opening;
a cover coupled to the box, the cover being configured to close off the opening in the box;
a first support member positioned in the box;
a first resistive heating element attached to a surface of the first support member;
a second support member attached to the cover;
a second resistive heating element attached to a surface of the second support member, wherein the surface of the second support member faces the surface of the first support member when the cover closes off the opening in the box, the surface of the second support member facing the surface of the first support member such that the first resistive heating element and the second resistive heating element face each other;
a living cell container positioned between the first resistive heating element and the second resistive heating element, the living cell container comprising living cells;
a temperature probe positioned between the first resistive heating element and the second resistive heating element;
a portable power source located in the box; and
at least one controller located in the box, the at least one controller being coupled to the first and second resistive heating elements, the temperature probe, and the portable power source, wherein the at least one controller is configured to control a temperature surrounding the living cell container by controlling electrical power provided to the first and second resistive heating elements from the portable power source, the temperature surrounding the living cell container being assessed using the temperature probe.

19. The system of claim 18, wherein the at least one controller is configured to control the temperature surrounding the living cell container within a desired range of a living-body temperature of the living cells.

20. The system of claim 19, wherein the system is configured to be transported from one location to another location while maintaining the living cells at the living-body temperature.
